(19) United States
(12) Patent Application Publication
(10) Pub. No.: US 2018/0240075 A1
(43) Pub. Date: Aug. 23, 2018

(54) OPTIMIZING INFRASTRUCTURE RESOURCES TO SUPPORT SCHEDULED ONLINE MEETINGS

(71) Applicant: Microsoft Technology Licensing, LLC, Redmond, WA (US)

(72) Inventors: Amer Hassan, Kirkland, WA (US); Bradford R. Clark, Broomfield, CO (US); Michael Travis Gilbert, Thornton, CO (US); David Anthony Lickorish, Sammamish, WA (US)

(21) Appl. No.: 15/436,699

(22) Filed: Feb. 17, 2017

(51) Int. Cl. G06Q 10/10; H04L 12/58

(52) U.S. Cl. CPC G06Q 10/1095; H04W 84/12; H04L 51/22

(57) ABSTRACT

Systems, methods, and software are disclosed herein to operate a calendar service to optimize infrastructure support for online meetings scheduled in the calendar service. In an implementation, the calendar service identifies an upcoming meeting from the meetings scheduled in the calendar service. The calendar service further identifies an infrastructure optimization to apply to the upcoming meeting. The calendar service requests an infrastructure management service to apply the infrastructure optimization to a resource during the upcoming meeting.

### TECHNICAL BACKGROUND

Office buildings include communication infrastructure to provide communication services such as telephony and Internet connectivity. The communication infrastructure may include components such as telephony equipment, telephone lines, Ethernet, computing devices, modems, wireless routers, and other infrastructure components. In addition to the physical infrastructure located on-site, companies may also use cloud computing services. Cloud computing allows users to access shared computer processing resources and data storage via the Internet. A cloud computing environment may provide access to a group of shared resources such as servers, storage, and applications and services.

Employees may use the physical communication infrastructure along with various software applications to communicate with co-workers, clients, or others during the course of their work day. For example, employees may use email, instant messaging, audio/video conference, and/or other software applications. The software applications may be stored locally or in a cloud environment. Events, such as meetings and video calls may be scheduled using the various software applications.

Employees may schedule and/or attend multiple events each day. For events such as a video conference, factors such as the strength or quality of a wireless signal may affect the quality of the video and/or audio of the video conference. The wireless signal may be affected by the location of the user relative to infrastructure components such as a wireless router. Wireless routers have antennas that may be configured to focus or amplify a wireless signal, which may improve the wireless signal for a user or a location.

### OVERVIEW

Technology is disclosed herein that optimizes infrastructure resources to support online meetings scheduled in a calendar service. In an implementation, the calendar service identifies an upcoming meeting from the meetings scheduled in the calendar service. The calendar service further identifies an infrastructure optimization to apply to the upcoming meeting. The calendar service also requests an infrastructure management system to apply the infrastructure optimization to a resource during the upcoming meeting.

The foregoing Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational environment to optimize infrastructure resources to support online meetings.

FIG. 2 illustrates a flow diagram illustrating example operations of a calendar service in an implementation.

FIG. 3 illustrates a flow diagram illustrating example operations of an infrastructure management service in an implementation.

FIG. 4 illustrates another operational environment to optimize infrastructure resources to support online meetings.

FIG. 5 illustrates an example of an office building in an implementation.

FIG. 6 illustrates an example of a new meeting request in an implementation.

FIG. 7 illustrates an operational sequence to optimize infrastructure resources for an online meeting scheduled in a calendar service in an implementation.

FIG. 8 illustrates a computing system suitable for implementing the software technology disclosed herein, including any of the applications, architectures, elements, processes, and operational scenarios and sequences illustrated in the Figures and discussed below in the Technical Disclosure.

### TECHNICAL DISCLOSURE

Technology is disclosed herein to optimize infrastructure resources to support online meetings scheduled in a calendar service. In an implementation, the calendar service identifies an upcoming meeting from the meetings scheduled in the calendar service. The calendar service further identifies an infrastructure optimization to apply to the upcoming meeting. The calendar service also requests an infrastructure management service to apply the infrastructure optimization to a resource during the upcoming meeting.

A technical effect provided by the technology disclosed herein is the ability to optimize infrastructure resources to support online meetings. More specifically, the technology allows infrastructure resources to be configured to provide optimized service to end users for their scheduled online meetings. For example, a wireless router may be configured to focus a wireless signal to a specified location during a scheduled video conference. In addition to optimizing infrastructure resources to support scheduled events, a health check may be performed on the infrastructure resources to ensure components are operational. If any issues are detected, an infrastructure management service may be notified of the issue. Additionally, the meeting participants may be notified of any infrastructure issues and provided with alternative locations where optimized service can be provided for the event. Additionally, meetings may be prioritized based on participants in order to resolve conflicts when two or more scheduled meetings require the use of the same resource(s).

In general, a new online meeting is created by a user using a computing device executing a software application. The software application may be a calendar service, although any type of application is possible. Although scheduling a new online meeting is described using a software application, the enhancements disclosed herein apply as well to scheduled events outside of the context of software applications. Furthermore, the calendar service may be a component of another application or service such as a video conferencing or email service.

The calendar service identifies an upcoming meeting. In some implementations, the calendar service determines the upcoming meetings for that day during off-peak hours, such as 2:00 am-3:00 am. After identifying the upcoming meeting(s), the calendar service identifies an infrastructure optimization to apply to the upcoming meeting and requests an infrastructure management service to apply the infrastructure optimization to a resource during the upcoming meeting. For example, the calendar service may determine an antenna configuration for a wireless router during the time of the upcoming meeting and send the antenna configuration to the infrastructure management service. The infrastructure management service configures the specified wireless router according to the antenna configuration. The upcoming meeting is conducted via a communication service, such as a video conferencing service.

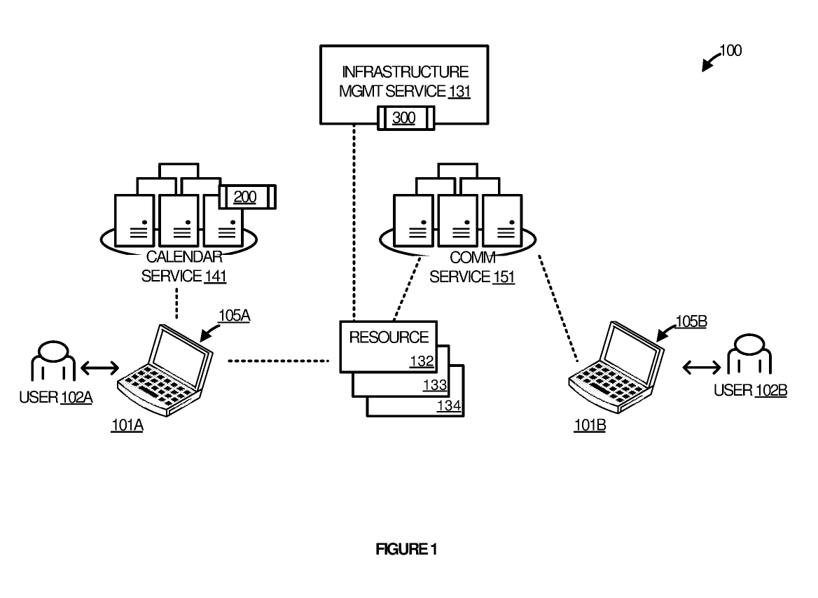

FIG. 1 illustrates operational environment 100 in an implementation. Operational environment 100 includes end-users 102, computing systems 101, infrastructure management service 131, resources 132-134, calendar service 141, and communication service 151. Computing systems 101 include user interfaces 105. Users 102, computing systems 101, and resources 132-134 may be co-located (e.g. in the same building or within the same office campus) or may be located in different locations.

Infrastructure management service 131 executes process 300. Infrastructure management service 131 manages resources 132-134. Calendar service 141 executes process 200. Users 102 may access communication service 151 via a network such as wireless and wireline networks, local area networks (LANs) and wide area networks (WANs), internets and intranets, the Internet, Voice over Internet Protocol (VoIP) networks, cable or fiber optic networks, and the public switched telephone network (PSTN), as well as any type or combination of networks.

Calendar service 141 is representative of any software application capable of scheduling new online meetings. Examples include, but are not limited to, calendar applications, email applications , social networking applications, business management applications, instant messaging applications, Exchange®, Skype® and Skype for Business®, and any other type of combination or variation thereof. Calendar service 141 may be integrated in the context of a larger communication application or may be implemented as a stand-alone application. Calendar service 141 may be implemented as a natively installed and executed application, a browser-based application, a cloud-based application, a streaming or streamed application, a mobile application, or in any other suitable manner

In operation, computing system 101A executes calendar service 141, which drives user interface 105A through which user 102A may interact with calendar service 141. For example, user 102A enters user input to generate a new online meeting. Computing systems 101 are representative of any computing system capable of running an application natively or in the context of a web browser, streaming an application, or executing an application in any other manner. Examples of computing systems 101 include, but are not limited to, personal computers, mobile phones, tablet computers, desktop computers, laptop computers, wearable computing devices, or any other form factor, including any combination of computers or variations thereof. Computing systems 101 may include various hardware and software elements in a supporting architecture suitable for providing calendar service 141.

Calendar service 141 identifies an upcoming meeting. In some implementations, notifications for upcoming meetings are pushed to calendar service 141 at a predetermined time prior to the scheduled time of the upcoming meeting. In the same or other implementations, calendar service 141 may determine meeting parameters, such as the meeting location, participants, and/or type. In addition, calendar service 141 may query infrastructure management service 131 for available resources. In the same or other implementations, infrastructure management service 131 responds to calendar service 141 with a list of available resources. Although not required, infrastructure management service 131 may also report the configurations of the available resources.

After identifying the upcoming meeting(s), calendar service 141 identifies an infrastructure optimization to apply to the upcoming meeting(s). For example, calendar service 141 may determine an antenna configuration for a wireless router (i.e. resource 132), located at or near the location of the upcoming meeting, to optimize the wireless signal to the location of the upcoming meeting. Calendar service 141 requests infrastructure management service 131 to apply the infrastructure optimization to resource 132 during the upcoming meeting. In some implementations, calendar service 141 may identify one or more infrastructure optimizations for one or more resources.

Infrastructure management service 131 configures the specified wireless router according to the antenna configuration. The upcoming meeting is conducted via communication service 151. Examples of communication service 151 include, but are not limited to, Voice over IP (VoIP) applications, video conference applications, and audio conference applications.

Infrastructure management service 131 is representative of any software application capable of managing infrastructure resources, such as routers, repeaters, amplifiers, modems, bridges, antennas, wireless access points, switches, servers, and/or wireless local area network (WLAN) components, including any combinations or variations thereof. Infrastructure management service 131 may be integrated in the context of a larger management application or may be implemented as a stand-alone application. Infrastructure management service 131 may be implemented as a natively installed and executed application, a browser-based application, a cloud-based application, a streaming or streamed application, a mobile application, or in any other suitable manner

In an implementation, calendar service 141 identifies an upcoming meeting between user 102A and user 102B. In this example, user 102A is the requestor or creator of the upcoming meeting. Calendar service 141 may query infrastructure management service 131 for information about resources 132-134. In the same or other implementations, calendar service 141 may identify the resources 132-134 that user 102A will require for the upcoming meeting. For example, infrastructure management service 131 reports that user 102A will use resource 132 for the upcoming meeting. Calendar service 141 identifies infrastructure optimizations for resource 132. Calendar service 141 requests infrastructure management service 131 to apply the infrastructure optimizations to resource 132. User 102A and User 102B conduct the upcoming online meeting via communication service 151.

In yet another implementation, calendar service 141 identifies an upcoming meeting, where user 102A is an invitee. Calendar service 141 identifies an infrastructure optimization to apply to the upcoming meeting and requests infrastructure management service 131 to apply the infrastructure optimization to the resource during the meeting. For example, the infrastructure optimization may comprise an antenna power configuration.

In this example, although user 102A was not the meeting requestor, calendar service 141 may be configured to identify infrastructure optimizations when the user is an invitee. For example, infrastructure optimization may be a setting that may be enable/disabled in calendar service 141. In the same or other implementations, calendar service 141 may ask the user if s/he desires infrastructure optimization. For example, the infrastructure optimization may be a selectable object included in the meeting reminder. In another example, a separate pop-up window may ask the user to accept or decline infrastructure optimization.

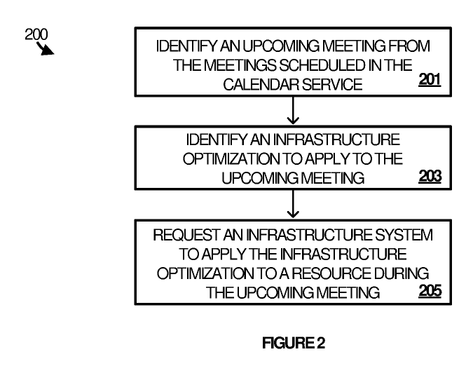

FIG. 2 illustrates process 200. Process 200 may be employed by calendar service 141 to optimize infrastructure resources to support online meetings. Some or all of the steps of process 200 may be implemented in program instructions in the context of the component or components of the application used to schedule the new online meeting. The program instructions direct calendar service 141 to operate as follows.

To begin, the calendar service identifies an upcoming meeting from the meetings scheduled in the calendar service (step 201). The meeting scheduled in the calendar service may be generated in response to a user input. The calendar service may send a notification in response to an upcoming meeting. For example, in conjunction with a meeting reminder, the calendar service may have a flag or any other type of notification, such as a passed parameter, polling, or callbacks that indicates an upcoming meeting. The value of the flag at any given time may signal upcoming meetings to the calendar service.

The calendar service identifies an infrastructure optimization to apply to the upcoming meeting (step 203). In some implementations, calendar service 141 may determine a location for the upcoming meeting and request information about resources located at or near the location for the upcoming meeting. In the same or other implementations, the calendar service may query a resource database for available resources. The calendar service requests the infrastructure management service to apply the infrastructure optimization to a resource during the upcoming meeting (step 205). For example, the calendar service may send configuration data over a network to the infrastructure management service.

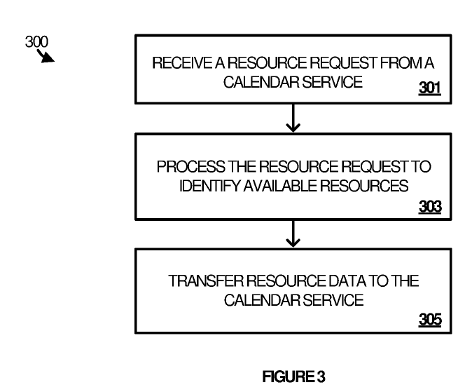

FIG. 3 illustrates the process 300. Process 300 may be employed by infrastructure management service 131 to optimize infrastructure resources to support online meetings. Some or all of the steps of process 300 may be implemented in program instructions in the context of the component or components of the application used to schedule the new online meeting. The program instructions direct infrastructure management service 131 to operate as follows.

To begin, infrastructure management service receives a resource request indicating parameters, such as a location, date, and time, for an upcoming meeting (step 301). The infrastructure management service processes the resource request to determine the resources required for the upcoming meeting (step 303). In this or other implementations, the infrastructure management service may determine how to configure the identified resources to optimize service during the upcoming meeting. The infrastructure management service transfers resource data to the calendar service (step 305).

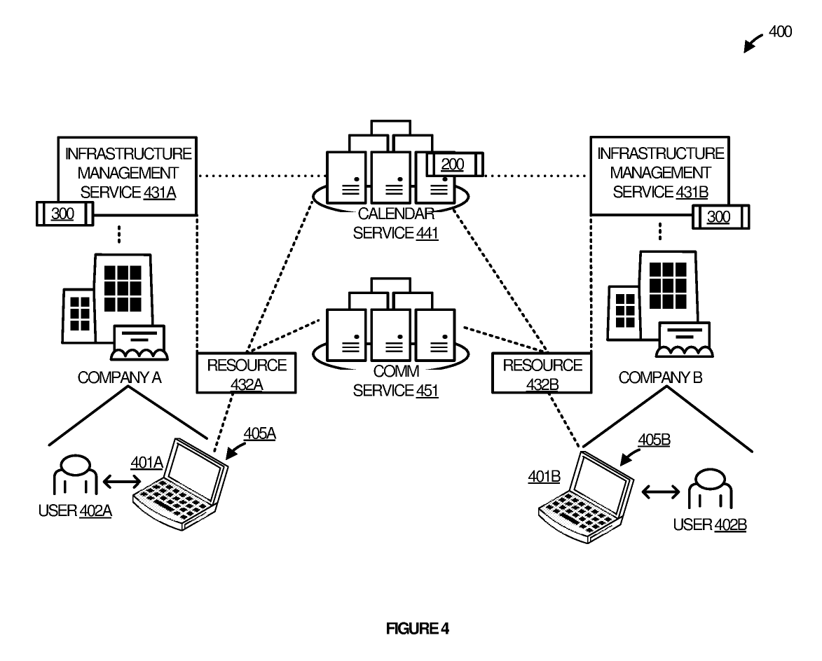

FIG. 4 illustrates an operational environment 400 in an implementation. Operational environment 400 includes end-users 402, computing systems 401, infrastructure management service 431, resources 432, calendar service 441, and communication service 451. Computing systems 401 include user interfaces 405. As shown, user 402A, computing system 401A, and resource 432A are located at the site for company A. User 402B, computing system 401B, and resource 432A are located at a separate location for company B.

Infrastructure management service 431 executes process 300. Infrastructure management service 431A manages resource 432A. Infrastructure management service 431B manages resource 432B. Calendar service 441 executes process 200. Calendar service 441 and communication service 451 may be stored in a cloud computing environment. Similar to FIG. 1, users 402 may access calendar service 441 and communication service 451 via a communication network such as an internet.

Calendar service 441 is representative of any software application capable of scheduling new online meetings. Examples include, but are not limited to, calendar applications, email applications, social networking applications, business management applications, instant messaging applications, Exchange®, Skype® and Skype for Business®, and any other type of combination or variation thereof. Calendar service 441 may be integrated in the context of a larger communication application or may be implemented as a stand-alone application. Calendar service 441 may be implemented as a natively installed and executed application, a browser-based application, a cloud-based application, a streaming or streamed application, a mobile application, or in any other suitable manner

In operation, computing systems 401 execute calendar service 441, which drives user interfaces 405 through which users 402 may interact with calendar service 441. For example, user 402A enters user input to generate a new online meeting in calendar service 441. At the same time or a later time, calendar service 441 identifies an upcoming meeting. After identifying the upcoming meeting(s), calendar service 441 identifies an infrastructure optimization to apply to the upcoming meeting. Calendar service 441 requests infrastructure management service 431 to apply the infrastructure optimization to resource 432A during the upcoming meeting.

In an implementation, user 402A, located in the building for company A, has an upcoming meeting with user 402B, located in company B's building. Calendar service 441 identifies the upcoming meeting between users 402A and 402B. Calendar service 441 identifies an infrastructure optimization, for resource 432A and 432B, to apply to the upcoming meeting. Calendar service 441 sends the infrastructure optimizations to the associated infrastructure management service 431A-B. Infrastructure management service 431A-B, apply their respective infrastructure optimizations for the upcoming meeting between users 402A and 402B.

In another implementation, each of users 402A and 402B have upcoming meetings with participants not shown for clarity. Calendar service 441 identifies an infrastructure optimization, for resource 432A and 432B, to apply to the upcoming meetings. Calendar service 441 sends the infrastructure optimizations to the associated infrastructure management service 431A-B. Infrastructure management service 431A-B, apply their respective infrastructure optimizations for the upcoming meetings.

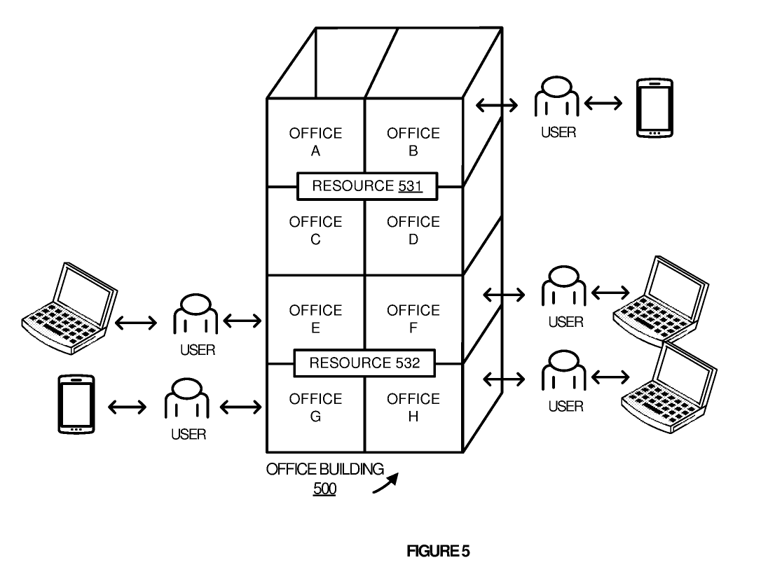

FIG. 5 illustrates an office building where the technology disclosed herein may be implemented. Office building 500 includes offices A-H and multiple users operating multiple computing devices, as shown. For example, the computing devices operated by users in offices E-H may be using resource 532. A calendar service identifies an upcoming meeting for the user in office F. The calendar service may identify that the user is operating a computing device that is accessing resource 532. The calendar service may further identify that the users in offices E, G, and H are operating computing devices that are also accessing resource 532. The calendar service identifies an infrastructure optimization to apply to the upcoming meeting for the user in office F. The infrastructure optimization may comprise instructing the computing device for the user in office F to switch to resource 531, since resource 532 is heavily loaded.

In another implementation, the calendar service may determine that the users in offices E and G have meetings scheduled off-site and are not in their offices or using resource 532. In this example, the calendar service identifies an infrastructure optimization for resources 532 and requests an infrastructure management service to apply the infrastructure management service to apply the infrastructure optimization to resource 532.

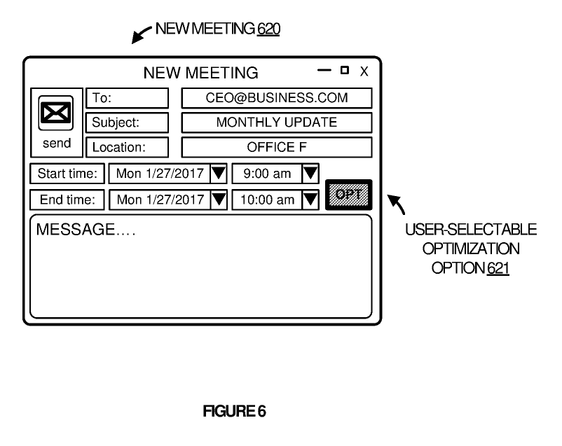

FIG. 6 illustrates an example of a new meeting request where the technology disclosed herein may be implemented. New meeting request 620 is an example of an online meeting that may be scheduled in a calendar service. New meeting 620 includes an invitee “ceo@business.com,” a subject “Monthly Update,” a location “Office F,” a start time “1/27/2017 9:00 am,” an end time “1/27/2017 10:00 am,” and a “message.” Optimization option 621 is a user-selectable feature, which when selected will invoke the operations to optimize infrastructure resources for the meeting. In an implementation, if the user selects optimization option 621, the calendar service used to generate new meeting 620, executes the operations described herein.

The online meeting generated from new meeting request 620 may also include information such as meeting type (i.e. video conference, audio conference, conference call, etc.), the participants' titles/position, a priority, required resources, etc. In some examples, a single resource may be configured to optimize upcoming meetings for multiple users. However, if there are two or more upcoming meetings scheduled at the same time and associated with the same resource(s) where the resource can only be optimized for one or some, but not all of the users, and calendar service 141 uses a priority to optimize the meeting for the higher priority user(s). For example, the calendar service may prioritize the meetings based on the participants/requestor. For instance, a meeting including the company's CEO may be given the highest priority. In the same of other implementations, when there is a conflict, the calendar service may determine an alternative location for the upcoming meetings that cannot be optimized. For example, the calendar service may suggest the non-optimized upcoming meeting(s) be conducted in alternate locations (i.e. a conference room rather than the requestor's office).

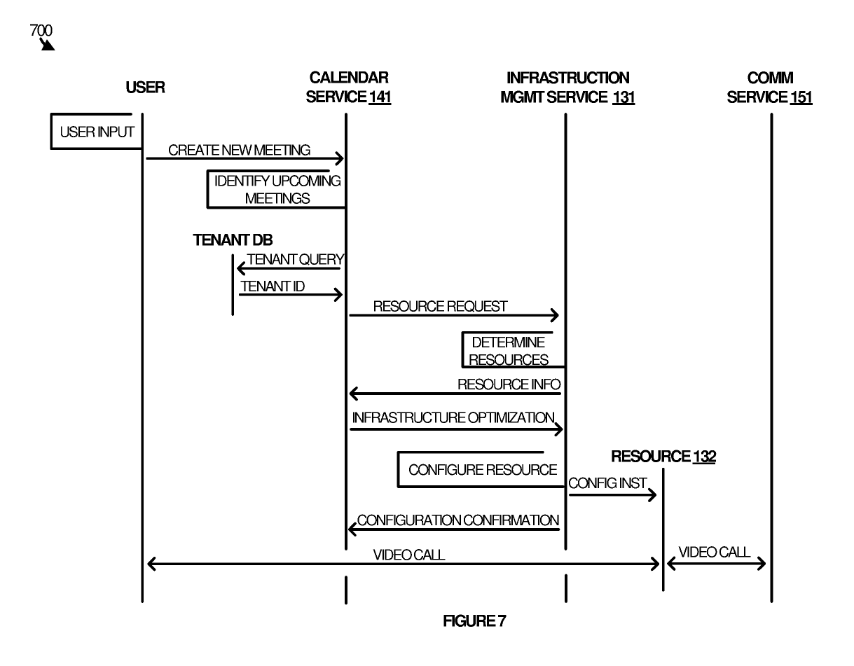

FIG. 7 illustrates operation 700. Operation 700 is an implementation of operational environment 100. In operation, a user enters user input to create a new online meeting via calendar service 141. Calendar service 141 identifies an upcoming meeting. The identified upcoming meeting may be the online meeting generated in the previous step, or another previously generated online meeting. After identifying the upcoming meeting, calendar service 141 queries a tenant database for tenant information, such as a tenant ID. In the same or other implementations, calendar service 141 may perform a Domain Name System (DNS) server look-up for infrastructure management service 131. Calendar service 141 sends a resource request to infrastructure management service 131.

Infrastructure management service 131 determines available resources. Infrastructure management service 131 may query a resource database to determine available resources and/or resource configuration information. For example, infrastructure management service 131 may query the resource database to determine resources located at or near the location of the upcoming meeting.

Using operational environment 100 as an illustrative example, infrastructure management service 131 may determine that resource 132 is located near the location (i.e. office F) of the upcoming meeting. Infrastructure management service 131 responds to the resource request with resource 132. Infrastructure management service 131 sends resource information to calendar service 141. Infrastructure management service 131 may also report the current configuration of resource 132. In the same or other implementations, infrastructure management service 131 may also provide calendar service 141 with a list of alternative resources (i.e. resources 133-134).

Calendar service 141 determines optimization instructions for resource 132 and transfers the infrastructure optimization to infrastructure management service 131. Infrastructure management service 131 applies the infrastructure optimization to resource 132. For example, infrastructure management service 131 may send antenna configuration instructions to resource 132 based on the optimization instructions from calendar service 141. Resource 132 configures one or more antennas based on the antenna configuration instructions from infrastructure management service 131. Although not required, infrastructure management service 131 transfers a configuration confirmation to calendar service 141. Calendar service 141 may notify the user that the infrastructure optimization was successfully implemented. A video call for the user is conducted via configured resource 132 and communication service 151.

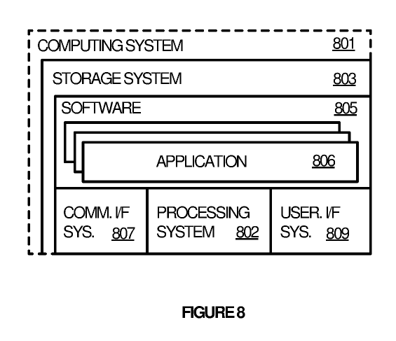

FIG. 8 illustrates computing system 801, which is representative of any system or collection of systems in which the various applications, services, scenarios, and processes disclosed herein may be implemented. Computing system 801 may be employed to execute a calendar service, infrastructure service, communication service, and/or other services, including combinations and variations thereof.

Examples of computing system 801 include, but are not limited to, personal computers, mobile phones, tablet computers, desktop computers, laptop computers, wearable computing devices, server computers, blade servers, rack servers, and any other type of computing system (or collection thereof) suitable for carrying out the optimization operations described herein. Such systems may employ one or more virtual machines, containers, or any other type of virtual computing resource in the context of supporting a calendar service for optimizing scheduled meetings.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809. In some implementations, user interface system 809 may be omitted. Computing system 801 may include other components omitted for clarity.

Processing system 802 loads and executes software 805 from storage system 803. Software 805 includes application 806 which is representative of the software applications discussed with respect to the preceding FIGS. 1-7, including calendar service 141 and 441. When executed by processing system 802, software 805 directs processing system 802 to operate as described herein for at least the various processes, operational scenarios, and sequences discussed in the foregoing implementations to optimize infrastructure resources to support online meetings. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device, but may also be distributed across multiple processing devices or sub-systems that cooperate in executing program instructions. Examples of processing system 802 include general purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device, but may also be implemented across multiple storage devices or sub-systems co-located or distributed relative to each other. Storage system 803 may comprise additional elements, such as a controller, capable of communicating with processing system 802 or possibly other systems.

Software 805 in general, and application 806 in particular, may be implemented in program instructions and among other functions may, when executed by processing system 802, direct processing system 802 to operate as described with respect to the various operational scenarios, sequences, and processes illustrated herein. For example, application 806 may include program instructions for identify upcoming online meetings and identify infrastructure optimizations to support the upcoming online meetings.

In particular, the program instructions may include various components or modules that cooperate or otherwise interact to carry out the various processes and operational scenarios described herein. The various components or modules may be embodied in compiled or interpreted instructions, or in some other variation or combination of instructions. Software 805 may include additional processes, programs, or components, such as operating system software, virtual machine software, or other application software, in addition to or that include application 806. Software 805 may also comprise firmware or some other form of machine-readable processing instructions executable by processing system 802.

In general, application 806 may, when loaded into processing system 802 and executed, transform a suitable apparatus, system, or device (of which computing system 801 is representative) overall from a general-purpose computing system into a special-purpose computing system customized to enhance calendar and communication operations. Indeed, encoding application 806 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, application 806 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here.

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface, in which a user interface to an application may be presented (e.g. user interfaces 105 and 405).

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols.

Certain inventive aspects may be appreciated from the foregoing disclosure, of which the following are various examples.

### Example 1

A computing apparatus comprising: one or more computer readable storage media; a processing system operatively coupled with the one or more computer readable storage media; and program instructions stored on the one or more computer readable storage media for optimizing infrastructure resources to support online meetings scheduled in a calendar service; wherein the program instructions, when executed by the processing system, direct the processing system to at least: identify an upcoming meeting from the meetings scheduled in the calendar service, identify an infrastructure optimization to apply to the upcoming meeting, and request an infrastructure management service to apply the infrastructure optimization to a resource during the upcoming meeting.

### Example 2

The computing apparatus of Example 1 wherein the resource comprises a Wireless Fidelity (Wi-Fi) router.

### Example 3

The computing apparatus of Examples 1-2 wherein the infrastructure optimization comprises a wireless router antenna configuration.

### Example 4

The computing apparatus of Examples 1-3 wherein the infrastructure optimization comprises a wireless router antenna power configuration

### Example 5

The computing apparatus of Examples 1-4 wherein the calendar service is included as part of a Voice over Internet Protocol (VoIP) application.

### Example 6

The computing apparatus of Examples 1-5 wherein the calendar service is included as part of an email application.

### Example 7

The computing apparatus of Examples 1-6 wherein the program instructions, when executed by the processing system, further direct the processing system to at least determine a location for the upcoming meeting.

### Example 8

The computing apparatus of Examples 1-7 wherein the program instructions, when executed by the processing system, further direct the processing system to at least determine a date and a time for the upcoming meeting.

### Example 9

The computing apparatus of Examples 1-8 wherein the program instructions, when executed by the processing system, further direct the processing system to at least determine a list of participants, the participants' names, and the participants' job titles for the upcoming meeting.

### Example 10

A method of operating a calendar service to optimize infrastructure support for online meetings scheduled in the calendar service, the method comprising: identifying an upcoming meeting from the meetings scheduled in the calendar service, identifying an infrastructure optimization to apply to the upcoming meeting, and requesting an infrastructure management service to apply the infrastructure optimization to a resource during the upcoming meeting.

### Example 11

The method of Example 10 wherein the resource comprises a

Wireless Fidelity (Wi-Fi) router.

### Example 12

The method of Examples 10-11 wherein the infrastructure optimization comprises a wireless router antenna configuration.

### Example 13

The method of Examples 10-12 wherein the infrastructure optimization comprises a wireless router antenna power configuration

### Example 14

The method of Examples 10-13 wherein the calendar service is included as part of a Voice over Internet Protocol (VoIP) application.

### Example 15

The method of Examples 10-14 wherein the calendar service is included as part of an email application.

### Example 16

The method of Examples 10-15 wherein the method further comprises determining a location for the upcoming meeting.

### Example 17

The method of Examples 10-16 wherein the further comprises determining a date and a time for the upcoming meeting.

### Example 18

The method of Examples 10-17 wherein the further comprises determining at least one of: a list of participants, the participants' names, and the participants' job titles for the upcoming meeting.

### Example 19

One or more computer readable storage media having program instructions stored thereon to optimize infrastructure support for online meetings scheduled in a calendar service, wherein the program instructions, when executed by a processing system, direct the processing system to at least: identify an upcoming meeting from the meetings scheduled in the calendar service, identify an infrastructure optimization to apply to the upcoming meeting, and request an infrastructure management service to apply the infrastructure optimization to a resource during the upcoming meeting.

### Example 20

The computer-readable storage media of Example 19 wherein the resource comprises a Wireless Fidelity (Wi-Fi) router.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A computer apparatus comprising:
one or more computer readable storage media;
a processing system operatively coupled to the one or more computer readable storage media; and
program instructions stored on the one or more computer readable storage media to operate a calendar service to optimize infrastructure support for online meetings scheduled in the calendar service, when executed by the processing system, direct the processing system to at least:
identify an upcoming meeting from the online meetings scheduled in the calendar service;
identify an infrastructure optimization to apply to the upcoming meeting; and
request an infrastructure management service to apply the infrastructure optimization to a resource during the upcoming meeting.

2. The computer apparatus of claim 1 wherein the resource comprise a Wireless Fidelity (Wi-Fi) router.

3. The computer apparatus of claim 1 wherein the infrastructure optimization comprises a wireless router antenna configuration.

4. The computer apparatus of claim 1 wherein the infrastructure optimization comprises a wireless router antenna power configuration.

5. The computer apparatus of claim 1 wherein the calendar service is included as part of a Voice over Internet Protocol (VoIP) application.

6. The computer apparatus of claim 1 wherein the calendar service is included as part of an email application.

7. The computer apparatus of claim 1, wherein the program instructions, when executed by the processing system, further direct the processing system to at least:
determine a location for the upcoming meeting.

8. The computer apparatus of claim 1, wherein the program instructions, when executed by the processing system, further direct the processing system to at least:
determine a date and a time for the upcoming meeting.

9. The computer apparatus of claim 1, wherein the program instructions, when executed by the processing system, further direct the processing system to at least:
determine a list of participants and the participants' job titles for the upcoming meeting.

10. A method of operating a calendar service to optimize infrastructure support for online meetings scheduled in the calendar service, the method comprising:
identifying an upcoming meeting from the online meetings scheduled in the calendar service;
identifying an infrastructure optimization to apply to the upcoming meeting; and
requesting an infrastructure management service to apply the infrastructure optimization to a resource during the upcoming meeting.

11. The method of claim 10 wherein the resource comprises a Wireless Fidelity (Wi-Fi) router.

12. The method of claim 10 wherein the infrastructure optimization comprises a wireless router antenna configuration.

13. The method of claim 10 wherein the infrastructure optimization comprises a wireless router antenna power configuration.

14. The method of claim 10 wherein the calendar service is included as part of a Voice over Internet Protocol (VoIP) application.

15. The method of claim 10 wherein the calendar service is included as part of an email application.

16. The method of claim 10 further comprising:
determining a location for the upcoming meeting.

17. The method of claim 10 further comprising:
determining a date and a time for the upcoming meeting.

18. The method of claim 10 further comprising:
determining at least one of: a list of participants, the participants' names, and the participants' job titles for the upcoming meeting.

19. One or more computer readable storage media having program instructions stored thereon to optimize infrastructure support for online meetings scheduled in a calendar service, wherein the program instructions, when executed by a processing system, direct the processing system to at least:
identify an upcoming meeting from the online meetings scheduled in the calendar service;
identify an infrastructure optimization to apply to the upcoming meeting; and
request an infrastructure management service to apply the infrastructure optimization to a resource during the upcoming meeting.

20. The one or more computer readable storage media of claim 19 wherein the resource comprises a Wireless Fidelity (Wi-Fi) router.
